(19) United States
(12) Patent Application Publication
(10) Pub. No.: US 2014/0110138 A1
(43) Pub. Date: Apr. 24, 2014

(54) PROTECTIVE APPARATUS IN CONNECTION WITH MACHINE TOOLS TO SAFEGUARD WORKLOAD INSTALLATION

(71) Applicants: David Andrew Zarrin, Saratoga, CA (US); Teresa Louise Zarrin, Saratoga, CA (US)

(72) Inventors: David Andrew Zarrin, Saratoga, CA (US); Teresa Louise Zarrin, Saratoga, CA (US)

(73) Assignee: David Zarrin

(21) Appl. No.: 13/657,920

(22) Filed: Oct. 23, 2012

(51) Int. Cl. B23Q 11/00; B23Q 5/04

(52) U.S. Cl. CPC B23Q 11/0085; B23Q 11/0092; B23Q 5/04
USPC 173/1; 173/2

(57) ABSTRACT

This invention is an installation of a protective apparatus to prevent safety problems of machine tools caused in machining work-load process. The protective apparatus is comprised of a circuit used to slowly rotate the loaded machine tool by stepping it at a low speed and low power one full turn to insure clear workload path, and before full power is applied. This protective system will activate the full power only if a full rotation is achieved without any obstacles caused by chuck wrench or work-load interference with machine parts. The machine will subsequently arm itself to go into full power rotation if the operator activates the machine within a short period of time after the safety rotation is completed. The safety cycle is performed each time the operator activates the machine tool. This protective apparatus keeps the machine tool in low-speed and low-power unless the safety cycle has been performed each time the machine tool is turned on.

### THE FIELD OF THE INVENTION

This invention is associated with a protective apparatus for preventing safety problems of machine tools with rotating workload and machine parts that require operator inspection of rotating parts prior to applying full power to machine tool.

### THE BACKGROUND OF THE INVENTION

The process of making parts from raw materials often requires the use of machining tools with rotating workload and machine chuck. Most machine tools such as lathe and milling machines are operated and monitored by an operator with limited protection. If the machine tool equipment is turned on without clearing the workload rotation path, it can result in serious injury to the operator and damage to workload, and machine tool. Therefore to insure safety around machine shops with moving or rotating parts, a protective apparatus to guard against operator error is required.

Experienced machine operators must manually rotate or slide the workload by hand one full cycle or rotation to insure clear path of workload prior to applying power to machine tools such as lathe or. If the workload is improperly mounted and the machine tool is turned on without manually rotating the machine tool, the force of full power rotation can cause significant injury to the operator, workload, and machine tool itself.

Prior inventions have relied on certain sensing devices to stop the rotating chuck. However, the safety sensors cannot judge whether a non-operational subject, for example an installed workload, has been installed properly to clear machine tool parts during the operation. In addition, such sensors do not stop the rotation of the workload fast enough to prevent the damage. Therefore, such methods fail to provide an effective and positive protection for the operators and workload in all cases.

Given that occupational injuries in machine shops are highly dependent on professional operator training, the design of a protective system to remove the need for highly trained operators greatly enhances the safety of the workplace and protects the operator, the workload and machine tool itself.

### THE SUMMARY OF THE INVENTION

The goal of this invention is to provide a protective, protective apparatus to prevent machining problems caused by improper installation of workload in machine tool. Prior to activating the machine tool power, the protective apparatus rotates the workload in micro steps at low power for one full cycle while checking completion of each micro step to insure a clear workload path around a full circle. The machine tool power is enabled for a short period after completion of the safety cycle allowing the operator to turn the machine on. If the designated time has elapsed, and the power has not been turned on by the operator, the protective apparatus will reset requiring another safety cycle to be performed.

### THE EMBODIMENTS OF THE INVENTION

FIG. 1 illustrates the concept of the protective apparatus of this invention. This protective apparatus 60 is comprised of: a workload chuck stepper motor 10, machine motor 20, position sensor 30, machine tool power switch 40, and a control unit 50.

The protective apparatus control unit 50 will activate the stepper motor 10 when the machine tool power switch 40 is activated. The control unit 50 steps the workload a full cycle in small increments while the position sensor 30 and control unit 50 validate the successful completion of each step. Depending on machine tool tolerance, the steps may be as small of 0.001 of an inch. The control unit 50 verifies the expected position of the rotor or workload carriage to insure there are no obstacles blocking the movement of the workload. This protective apparatus will keep the main power to machine tool in the power-off status until one full cycle has been completed without a blockage caused by incorrect mounting of the workload.

This protective system 60 will activate the workload chuck stepper motor 10 for one full cycle or rotation at low power when the machine operator turns on the power switch. The control unit 50 keeps the machine tool in power-off status while completing the safety cycle. The position sensor 30 provides the position of workload chuck stepper motor 10, or workload after each step. The control unit 50 checks the position of the workload chuck 10, and workload after each step to ensure the workload chuck 10 has advanced to the next position without interference caused by improper workload installation. The control unit 50 keeps the machine motor 20 in power-off status until a full cycle or rotation is achieved and the operator has activated the power switch again within a designated time.

This protective apparatus 60 will keep the power to the machine motor 20 in power-off state until the workload chuck 10 has successfully advanced a full cycle. The control unit 50 will alert the operator if the workload chuck 10 does not successfully advance as expected.

This preventive measure is implemented to prevent the situation where improper work-loading device interferes with machine tool itself caused by the operator's negligence.

The basic mechanism for the control unit 50 is based on whether the work-loading device has completed one full cycle or rotation in successions of micro increments and returned to the starting position at which time the main machine tool motor is armed to be powered on within designated time.

FIG. 2 shows the flow chart for the embodiment of FIG. 1. The process flow encompasses the following steps:

STEP 100: turn on the power of the machine tool; execute STEP 101.

STEP 101: Single step the machine workload in its path and then, execute STEP 103.

STEP 102: check current position of the machine chuck or carriage whether the single step operation was successful; execute STEP 104, if “yes”; go to STEP 103, if “no”.

STEP 103: The safety cycle failed to complete. Alert the operator. The machine tool operation is kept paralyzed, and the flow is ended by executing STEP 100.

STEP 104: check current position of the machine chuck or carriage whether a full cycle rotation is completed successfully; execute STEP 105, if “yes”; go to STEP 101, if “no”.

STEP 105: The safety cycle has been completed. Check current status of the machine power. If operator re-activated the power switch execute STEP 107, if “no” execute STEP 100.

STEP 107: Check if operator has turned off the machine power. if “yes”; go to STEP 100, if “no” execute STEP 107.

This invention provides a protective apparatus to prevent safety problems of a machine tool caused in work-loading process, and provides a safety mechanism for the operation mode of the machine tool. Damages to the machine tool and human injury can then be further reduced if normal safety procedures are taken in conjunction with this protective apparatus.

Through the abovementioned preferable description of the embodiments of this invention, hopefully the features and main spirit are clearly described. But the description doesn't limit the scope of this invention. From other viewpoint, the purpose of this description is made to cover any change or equivalent rearrangement within the scope of this invention.

### BRIEF DESCRIPTION OF THE DRAWINGS

FIG. 1 illustrates a concept of the protective apparatus of this invention;

FIG. 2 shows the flow chart for the embodiment of FIG. 1.

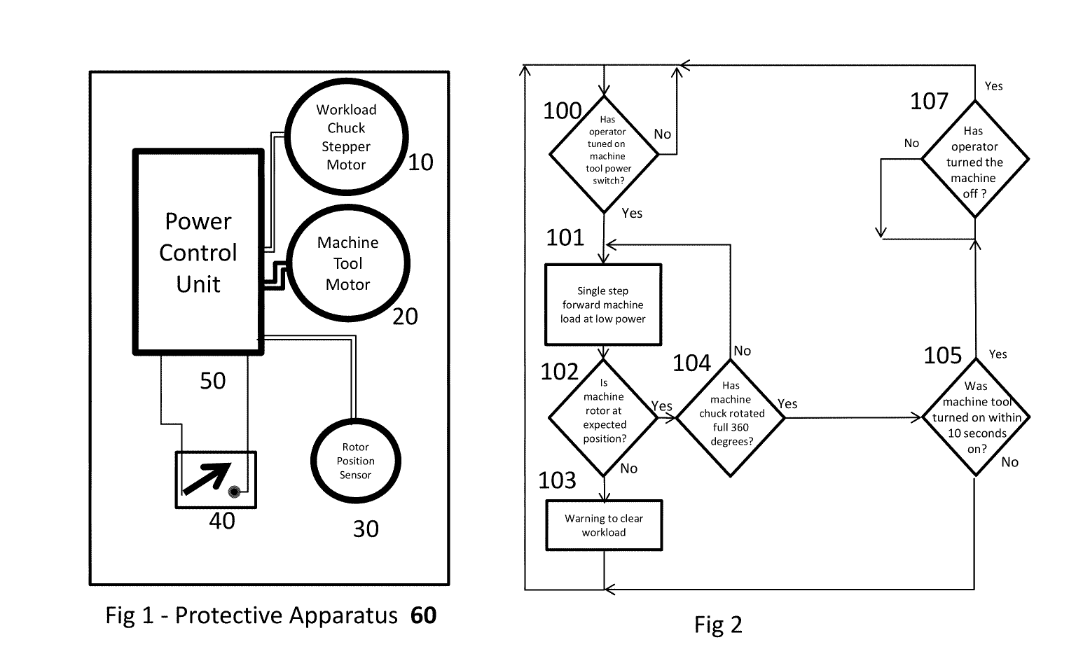

1. An apparatus for preventing industrial machining tool problems caused in the work loading process, is comprised of a workload chuck stepper motor and workload chuck position sensor to control the on-off switch of the machine tool through a control unit which steps the workload chuck and workload one full cycle in micro increments to insure clear workload travel path before enabling power to machine tool on/off switch.

2. The protective apparatus of claim 1, wherein the protective apparatus controls the machine tool on-off switch by putting the machine tool in power off status until the machine tool chuck and workload has been completed one full rotation and return to the starting position.

3. The protective apparatus of claim 1, wherein the workload is stepped through its rotation path and each incremental step motion of the machine chuck and workload position is verified by a position sensor.

4. The protective apparatus of claim 1, wherein the workload position sensor validates the new position of the workload as the machine tool chuck advances the workload position through its path.

5. The protective apparatus of claim 1, wherein a control unit keeps the machine tool in power off state until a full cycle of machine tool chuck and workload has completed without exhibiting any obstacles.

6. The protective apparatus of claim 1, wherein a safety control unit allows the operator to turn the machine tool on within a designated window in time after a safety cycle has been completed.

7. A method for preventing industrial safety problems of a machine tool caused in the work-loading process, comprised of: (1) a mechanism enabling the power circuits of the machine tool for a period of time after a safety cycle is completed; (2) a protective apparatus that can accommodate the work-loading device and is in connection with circuits of the machine tool, wherein after the work-load advances a full rotation, the machine tool power is enabled; (3) controlling the machine tool power status based on whether the work-load has successfully single-stepped through one full rotation cycle and returned to its initial starting position.
